(19) United States
(12) Patent Application Publication
(10) Pub. No.: US 2008/0285013 A1
(43) Pub. Date: Nov. 20, 2008

(54) Method of Checking the Filling Volume of Blisters

(75) Inventors: Richard Mertens, Laupheim (DE); Heino Prinz, Laupheim (DE)

Correspondence Address: JANSSON SHUPE & MUNGER LTD., 245 MAIN STREET, RACINE, WI, 53403, US

(73) Assignee: Uhlmann VisioTec GmbH, Laupheim (DE)

(21) Appl. No.: 12/118,844

(22) Filed: May 12, 2008

(30) Foreign Application Priority Data
May 14, 2007 (EP) EP 07 009 646.6

(51) Int. Cl. G01J 3/00

(52) U.S. Cl. 356/51

(57) ABSTRACT

A method for checking the volume of material in the form of a thin layer of a powdery substance in pockets of a blister pack including: bringing at least one blister pack to the measuring area of a measuring system, the pack including a plurality of pockets which are designed to be reflective and are filled with a thin layer of the substance; exposing the substance in at least one of the pockets to near-infrared radiation; recording at least partial ranges of an actual reflectance spectrum for each pocket by detecting the radiation reflected from the pocket; calculating actual values associated with the intensities displayed in the actual reflectance spectrum for at least partial ranges of the actual reflectance spectrum; comparing, in at least partial ranges of the actual reflectance spectrum, the calculated actual values with corresponding reference values associated with the intensities displayed in at least one model spectrum; and checking the ratio of the layer thickness to the density of the powdery substance as a function of the result of the comparison.

### CROSS REFERENCE TO RELATED APPLICATION

This application claims priority based on European patent application EP 07 009 646.6, filed May 14, 2007.

### FIELD OF THE INVENTION

The present invention relates to methods for checking the volume of material in the form of a thin layer of a powdery substance in the pockets of blister packs.

### DESCRIPTION OF THE PRIOR ART

Up until a few years ago, drugs in powder form in the pockets of blister packs were weighed by highly complicated weighing machines to ensure that the correct quantities of the powdery substance were in the pockets. Because of the complexity of the weighing machines, however, it was possible only to take random samples.

As an improvement, it was proposed that the volumes of the small quantities of powder in the blister pack pockets be measured by means of capacitive measurement sensors. A method of this type is known from EP 1 193 177 A, for example. In this method, the capacitive measurement parameters of the powdery substance in the individual pockets of a blister pack are measured, and the amount present in each pocket of the blister pack can be determined on the basis of the values thus obtained. The disadvantage of these types of methods is that the measurement sensor system is highly complicated, because a separate sensor and its associated electronics must be provided for each individual pocket.

Measuring devices which operate in the near-infrared are also known. They can record the NIR spectra of molecular mixtures present in tablets or powdery substances (e.g., EP 0 887 638 A). By comparing the relative absorption intensities at product-specific wavelengths, it is possible to draw conclusions about the relative weight distribution, that is, the concentration, of the individual substances in the mixture. An absolute determination of the quantity of a mixture of solids or powders, however, is normally not possible by means of NIR spectroscopy, because, as a result of the so-called anisotropy effect, the spectroscopic response signal is not directly proportional to the thickness of the layer through which the radiation passes.

### SUMMARY OF THE INVENTION

It is an object of the present invention to provide a method for checking the volume of material in the form of a thin layer of a powdery substance filling the pockets of a blister pack by means of which, even at high production speeds of the blister packaging machines, it is possible to monitor the amount of substance filling each individual pocket in a reliable and rapid manner without the need for a complicated apparatus.

The inventive method for checking the volume of material in the form of a thin layer of a powdery substance filling the pockets of a blister pack comprises the following steps: providing at least one blister pack arranged in the measuring area of a measuring device, the blister pack including a plurality of pockets which are designed to be reflective and are filled with a thin layer of a powdery substance; exposing the powdery substance in at least one of the pockets of the blister pack to near-infrared radiation; recording at least partial ranges of an actual reflectance spectrum by detecting the radiation reflected from the pocket; calculating actual values associated with the intensities displayed in the actual reflectance spectrum for at least partial ranges of the actual reflectance spectrum; comparing, in at least partial ranges of the actual reflectance spectrum, the calculated actual values with corresponding reference values associated with the intensities displayed in at least one model spectrum; and checking the ratio of the layer thickness to the density of the powdery substance as a function of the result of the comparison.

On the basis of the proportionality between the ratio of the layer thickness to the density of the powdery substance and the quantity of the powdery substance, it is guaranteed that the volume of powdery substance can be verified easily in almost any desired number of pockets without having to reduce the speed of the production and packaging lines.

In the normal case, each model spectrum will be obtained by means of the following steps: providing at least one blister pack with a plurality of pockets, which are filled with a powdery substance in a predetermined layer thickness; exposing the powdery substance in at least one of the pockets of the blister pack to near-infrared radiation; and recording at least partial ranges of a model spectrum by detection of the radiation reflected from the pocket. In this way, a reliable model spectrum is created, which is calibrated to the specific properties of the powdery substance to be tested and to the geometric conditions of the measurement.

So that data which can be compared with each other can be extracted easily from the spectra, the reference values are calculated from the model spectrum in the same way that the actual values are calculated from the actual reflectance spectrum.

Another advantage of the inventive method is that several blister packs can either be conveyed at intervals on a conveyor belt to the measuring area of the measuring device or be conveyed continuously on the conveyor belt through the measuring area of the measuring device.

So that the spectra can be recorded quickly, it is advantageous to detect the radiation reflected from the pocket by using two mirrors, each being capable of moving in one direction, to transmit the reflected radiation to a spectrometer. Thus, even when only one spectrometer is used, all of the pockets of the blister packs located in the measuring area can be checked in succession in extremely short periods.

To ensure the quality of the inspection procedure, it is advantageous to record several different model spectra as a function of the local orientation of each individual pocket.

To avoid even very small deviations in measurement accuracy, the center of gravity of the powdery substance in the pocket is preferably detected by a camera and calculated before the powdery substance is exposed to near-infrared radiation. The mirrors are then adjusted on the basis of the center of gravity thus determined.

Because the reflectance spectra change considerably depending on the degree of compaction of the powdery substance, it is advantageous to use a camera to check the two-dimensional area covered by the powdery substance and thus to determine its degree of compaction before the powdery substance is exposed to near-infrared radiation.

In a special embodiment which facilitates the comparison of the intensity curves, the actual values and the reference values are calculated as the first or second derivatives of the intensity curves of the actual reflectance spectrum and of the model spectrum. It is also possible, however, to use other mathematical methods such as rotation correction or wavelet analysis.

In an embodiment of the inventive method used to detect incorrect fill levels, the comparison of the actual values with the reference values is given a negative evaluation if the actual values differ from the reference values by a predetermined value, as a result of which a rejection criterion for the blister pack is created.

It is especially advantageous to compare the actual values with reference values of several model spectra recorded from powdery substances of different layer thicknesses and different densities.

### BRIEF DESCRIPTION OF THE DRAWINGS

Additional details, features, and advantages of the method according to the invention can be derived from the following description, which refers to the drawings.

FIG. 1 is a perspective schematic diagram of an NIR measuring system for implementing the inventive method for checking the volume of material in the form of a thin layer of a powdery substance filling the pockets of a blister pack;

FIG. 2 is a flow diagram of a preferred way of recording the model spectra used in the inventive method; and

FIG. 3 is a flow diagram of the inventive method for checking the volume of material in the form of a thin layer of a powdery substance filling the pockets of a blister pack.

### DETAILED DESCRIPTION OF THE INVENTION

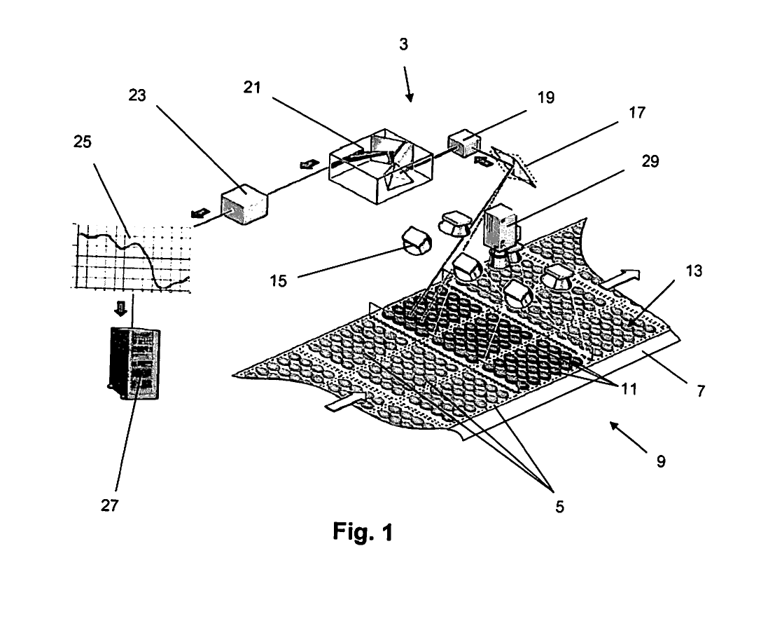

FIG. 1 shows an NIR measuring system 3 suitable for implementing the inventive method. The blister packs 5 to be inspected are transported on a conveyor belt 7 either at intervals or continuously to the measuring area 9 of NIR measuring system 3. As shown in FIG. 1, several blister packs 5 can be arranged next to each other on conveyor belt 7, and each one of these packs can have any number of pockets 11, which are usually arranged in rows and columns.

The pockets 11 curve downward toward conveyor belt 7 and are filled with a powdery substance 13, which forms only a thin layer in each pocket 11. For the inventive method, layer thicknesses in the range of 0.5-1.5 mm are preferred, but good results can be obtained at thicknesses of up to about 2 mm.

Individual pockets 11 consist, for example, of aluminum or some other reflective material and are not yet covered by a protective film, so that the measurement for checking the volume of material in pockets 11 can be conducted without difficulty. Pockets 11 are sealed after the quality control procedure.

It is preferable for individual blister packs 5 to be sent to measuring area 9 in repeating patterns, such as in rows of three, as shown in FIG. 1. Even at high speeds of conveyor belt 7, the inventive method will still be able to check all of pockets 11 of each individual blister pack 5 at a rate of up to 200 pockets per second.

NIR measuring system 3 consists of one or preferably a plurality of NIR lamps 15, which cover the entire measuring area 9 with near-infrared radiation. After spectroscopic absorption, some of the exciting uniform NIR light is reflected in all directions directly by the molecular crystals as it passes through the powdery substance 13. Some of the reflected radiation, however, as well as the unabsorbed exciting NIR light pass through the entire layer of powdery material 13 and is reflected from the bottom of pocket 11, whereupon it interacts again with the powder mixture. The light reflected in this way from pocket 11 has, at least in partial ranges of the spectrum, an absolute intensity correlation with the thickness of the layer through which it has passed—which is surprising. It is assumed that the initial anisotropic scattering is homogenized by specular reflection from the bottom of the pocket and by the second passage of the NIR radiation through the powdery substance, and as a result the intensity of the radiation reflected from the pocket is proportional to the thickness of the irradiated layer.

In the normal case, a mirror 17 which can move in an x-direction and a mirror which can move in a y-direction (only one mirror being shown in FIG. 1, however, for the sake of simplicity) are used to receive the radiation reflected from the pockets and to transmit it by way of a fiber-optic cable 19, for example, to a spectrometer 21. In spectrometer 21, the radiation is divided into its various wavelengths, and the signals are converted into an intensity spectrum 25 by an analog-to-digital converter 23. This intensity spectrum 25 can extend over the entire NIR range or only parts of it. The resulting intensity curve indicates the intensity of the reflected radiation for each wavelength. Both the model spectra 25a and the actual reflectance spectra 25b recorded during the actual inspection can be converted to intensity spectra 25. Recorded spectra 25a, 25b are evaluated in an evaluation unit 27.

As an option, a camera 29 upstream of measurement area 9 or directly above measurement area 9 can be provided, which performs a preliminary inspection of pockets 11 to determine if there are any empty ones or if powdery substance 13 has been compacted too much. The latter can be determined by the size of the two-dimensional area covered by the powder: a highly compacted powder covers a smaller area. In addition, the camera 29 can be used to determine the center of gravity of powdery substance 13 in various pockets 11, whereupon the electronically controlled movements of the mirror 17 are adjusted in such a way that the beam conducted to the spectrometer 21 is always reflected from the center of gravity of a pocket 11. Otherwise, the measurement is simply conducted in center of pocket 11. The process of controlling the movements of the mirrors is extremely complex and is carried out automatically by means of a control unit (not shown). Sequences of mirror movements preprogrammed in the control unit can be initiated, or these sequences can be modified rapidly in coordination with the signals sent by the camera 29 pertaining to the associated center of gravity of the powdery substance in pocket 11.

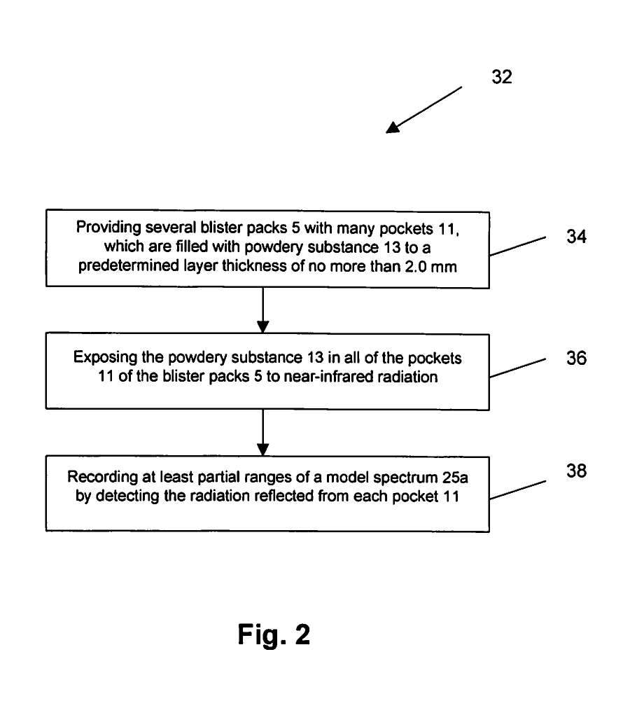

FIG. 2 is a flow diagram of a method 32 for recording a model spectrum 25a, which is compared, during the subsequent check of the volume of material in pockets 11, with the actually recorded actual reflectance spectrum 25b of pocket 11 to be checked. It is also possible to use, as model spectrum 25a, a spectrum obtained by averaging earlier measurement results or by derivation from a similar measurement spectrum of a substance with slightly different properties, e.g., a slightly different layer thickness or a slightly different composition.

In the normal case, however, a model spectrum for a pocket 11 is obtained by bringing several blister packs 5 with many pockets 11 into measuring area 9, where powdery substance 13 has a previously determined layer thickness of no more than 2.0 mm, preferably of 0.5-1.5 mm, and a certain desired degree of compaction (step 34). As previously described, it is possible to record model spectra 25a for many different pockets 11 simultaneously by the use of the movable mirrors 17 and the spectrometer 21, where it is extremely important to calibrate the system for the position of each pocket or of each detector angle.

In addition to a fixed angle of radiation and a fixed detector angle, another important basis for establishing the correct correlation between signal intensity and layer thickness is the assumption of a constant average density of the powder mixture over the course of the measuring time. If this cannot be guaranteed, it will be necessary not only to conduct the basic measurement itself but also to determine a correlation coefficient, which is then used to select multiple calibration functions prior to the actual measurement. In all cases, the ratio obtained between the layer thickness and the density of the powdery substance is directly proportional to the quantity of the powdery substance.

When powdery substance 13 in all pockets 11 of blister packs 5 is exposed by the NIR lamps 15 to near-infrared radiation (step 36), the radiation reflected from pockets 11 is conducted via mirrors 17 and the fiber-optic cable 19 to spectrometer 21 and converted by the A/D converter 23 into model spectrum 25a (step 38).

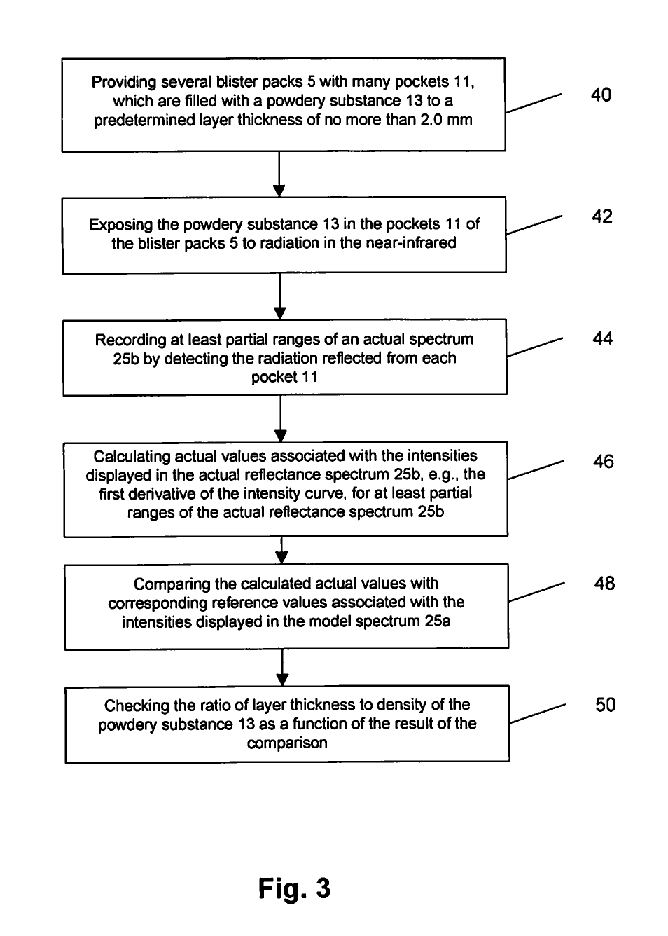

FIG. 3 shows a standard sequence of the inventive method for checking the filling amount in the pockets of blister packs. As in the case of the recording of model spectrum 25a, several blisters 5 with a plurality of pockets 11, which are filled with a powdery substance 13 to a layer thickness of no more than 2.0 mm, are conveyed by conveyor belt 7 into measuring area 9 of NIR measuring device 3 (step 40). Powdery substance 13 in pockets 11 of blister packs 5 is exposed by means of NIR lamps 15 to near-infrared radiation (step 42). At least certain partial ranges of the radiation reflected from each pocket 11 are converted to an actual reflectance spectrum 25b (step 44), where the generation of actual reflectance spectrum 25b proceeds in a manner analogous to recording of model spectrum 25a, which was described above with reference to FIG. 2.

In an evaluation unit 27, actual values associated with the intensities displayed in actual reflectance spectrum 25b are now calculated in step 46. Examples of these actual values are the intensity curve itself, the first derivative of the intensity curve, and the second derivative of the intensity curve. It is also possible, however, to calculate other actual values which are in direct relationship to the recorded intensities by means of mathematical methods such as rotation correction or wavelet analysis. In step 48, the calculated actual values are compared in the evaluation unit 27 with corresponding reference values, which are associated with the intensities displayed in model spectrum 25a in exactly the same way, if possible, as the actual values are associated with the intensities in the actual reflectance spectrum. In the calculation of the reference values, it is preferable to use the same calculation steps as those used to calculate the actual values.

It was discovered that, depending on the powdery substance to be tested, at least certain ranges of the spectra show deviations between the actual values and the reference values for different layer thicknesses of powdery substance 13. By evaluating these ranges, the layer thickness of powdery substance 13 in each pocket 11 can be checked as a function of the result of the comparison (step 50).

As already mentioned above, an additional camera 29 in the visible light range can be used to determine the center of gravity of powdery substance 13 in individual pockets 11 and/or to conduct a preliminary inspection of the compaction of powdery material 13 on the basis of the two-dimensional area which the powder material covers in pocket 11.

It is also possible, however, to conclude that powdery material 13 is too highly compacted on the basis of the fact that the intensity values of the actual reflectance spectrum 25b obtained for a compacted material differ clearly from the actual values obtained for a looser powder 13.

It is therefore advantageous to establish a correlation between the spectra and the ratio of the layer thickness to the density of powdery substance 13 on the basis of many different model spectra 25a recorded for different densities of powdery substance 13.

Thus both blister packs 5 in which the amount filling a pocket 11 is outside the preset tolerances and packs in which the material is overly compacted can be sorted out.

In this way, a method for checking the filling amount in pockets 11 of various blister packs 5 is created, by means of which, in a reliable manner, even at high production speeds, each individual pocket 11 of all blister packs 5 can be automatically checked by means of a single measuring device 3.

1. A method for checking the volume of material in the form of a thin layer of a powdery substance filling the pockets of at least one blister pack, comprising the steps of:
providing at least one blister pack arranged in the measuring area of a measuring system, the blister pack including a plurality of pockets which are designed to be reflective and are filled with a thin layer of a powdery substance;
exposing the powdery substance in at least one of the pockets of the blister pack to near-infrared radiation;
recording at least partial ranges of an actual reflectance spectrum for each pocket by detecting the radiation reflected from the pocket;
calculating actual values associated with the intensities displayed in the actual reflectance spectrum for at least partial ranges of the actual reflectance spectrum;
comparing, in at least partial ranges of the actual reflectance spectrum, the calculated actual values with corresponding reference values associated with the intensities displayed in at least one model spectrum; and
checking the ratio of the layer thickness to the density of the powdery substance as a function of the result of the comparison.

2. The method of claim 1 wherein the reference values are calculated from the model spectrum in the same way as the actual values are calculated from the actual reflectance spectrum.

3. The method of claim 1 wherein each model spectrum is obtained by:
providing at least one blister pack with a plurality of pockets which are filled with a powdery substance in a predetermined layer thickness;
exposing the powdery substance in at least one of the pockets of the blister pack to near-infrared radiation; and
recording at least partial ranges of a model spectrum for each pocket by detecting the radiation reflected from the pocket.

4. The method of claim 3 wherein the reference values are calculated from the model spectrum in the same way as the actual values are calculated from the actual reflectance spectrum.

5. The method of claim 1 wherein several blister packs are conveyed on a conveyor belt at intervals to the measuring area of the measuring system.

6. The method of claim 1 wherein several blister packs are conveyed on a conveyor belt continuously through the measuring area of the measuring system.

7. The method of claim 1 wherein the radiation reflected from the pocket is detected by using two mirrors, each of which being designed to move in one direction, to transmit the reflected radiation to a spectrometer.

8. The method of claim 7 wherein several different model spectra are recorded as a function of the local orientation of each pocket.

9. The method of claim 8 wherein, before the powdery substance is irradiated with near-infrared radiation, the center of gravity of the powdery substance in each pocket is recorded by means of a camera and calculated, and wherein the mirrors are adjusted to the center of gravity in question.

10. The method of claim 1 wherein, before the powdery substance is irradiated with near-infrared radiation, the two-dimensional area covered by the powdery material and thus its degree of compaction are checked by means of a camera.

11. The method of claim 1 wherein the actual values and the reference values are calculated as first or second derivatives of the intensity curves of the actual reflectance spectrum and of the model spectrum, or other mathematical methods such as rotation correction or wavelet analysis are used.

12. The method of claim 1 wherein the comparison of the actual values with the reference values is given a negative evaluation if the actual values differ from the reference values by a predetermined value, as a result of which a rejection criterion for the blister pack is produced.

13. The method of claim 1 wherein the actual values are compared with the reference values of several model spectra, which were recorded with powdery substances of different layer thicknesses and different densities.
